(19) United States
(12) Patent Application Publication
(10) Pub. No.: US 2004/0215690 A1
(43) Pub. Date: Oct. 28, 2004

(54) System and method for tracking and targeting editorial opportunities

(76) Inventor: Stephen W.T. O'Keeffe, Alexandria, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/768,144

(22) Filed: Feb. 2, 2004

Related U.S. Application Data
(60) Provisional application No. 60/444,199, filed on Feb. 3, 2003.

(51) Int. Cl. G06F 15/16

(52) U.S. Cl. 709/200

(57) ABSTRACT

A method and system for the tracking and targeting editorial opportunities. Multiple technical categories are defined for the editorial opportunities in order to alert category subscribers of upcoming editorial opportunities. An editorial calendar is obtained from trade publications pertinent to the multiple technical categories. A plurality of upcoming feature editorial opportunities are identified and the writer assigned to prepare each article is determined and contacted to determine the article focus and a deadline for the editorial opportunity. Each upcoming editorial opportunity is assigned to the category that best matches its focus. A database record is created for each article that includes the assigned writer, feature deadline, feature focus and technology category. The database records are stored in a database and provided to subscribers to the corresponding technical category. The editorial opportunity database can be searched by PR professionals for editorial opportunities in particular categories.

### CROSS-REFERENCE TO RELATED APPLICATIONS

This application claims the benefit under 35 U.S.C. 119(e) of Application Ser. No. 60/444,199, entitled “System and Method for Tracking and Targeting Editorial Opportunities,” filed Feb. 3, 2003, which is incorporated herein by reference in its entirety.

### BACKGROUND OF THE INVENTION

The invention is generally related to public relations information systems. More particularly, the invention is directed to a method and system for tracking editorial opportunities through a central online source.

Companies often attempt to publicize their business in various publications such as trade magazines, business periodicals, newspapers and the like. While companies are occasionally contacted to be the focus of an article, it is more frequent that the company featured in a particular article was selected based on a referral from a public relations professional. This is the case because it is difficult for individual companies to obtain information about what features or articles certain periodicals/publications intend to publish from month to month.

While publications issue annual editorial feature calendars that outline what features they will focus on for a given time period, these documents typically do not list assigned writers, feature focus, or editorial deadlines. The process of tracking editorial calendars; identifying relevant upcoming features; contacting the publications to identify the writer assigned; contacting the writer to understand the feature's focus and deadline; is a massive resource drain on public relations (PR) firms and corporate/in-house PR departments. Industry sources estimate that 30 percent of all PR time is dedicated to this function. Based on recent technology agency revenues, the cost of the editorial feature tracking process exceeds $267 billion, and this still significantly underestimates the expense, as it fails to factor resource commitments of in-house corporate PR functions.

From the editorial community's standpoint, technology reporters and editors are barraged by hundreds of redundant telephone calls and e-mails from PR professionals attempting to identify the assigned reporter, article focus, and editorial deadline assigned to a feature. This repetitive communication function wastes journalists' time and often generates friction between the journalism and public relations communities.

### SUMMARY OF THE INVENTION

The invention is directed to a Web-based service that facilitates focused interaction among public relations professionals and key media outlets (e.g., technology trade publications). The invention allows PR professionals to automatically track and target relevant feature editorial opportunities, while freeing journalists from being asked to provide hundreds of PR professionals with redundant information on each feature article. Specifically, the invention provides targeted access to all the editorial features mapped on the annual editorial calendars of various publications.

In one aspect of the invention, a method is provided including receiving data associated with at least one editorial opportunity, the data based on features contained in at least one editorial calendar. The received editorial opportunity is associated with at least one of a client and a category from a plurality of categories. Information is received that is associated with a data record for the at least one editorial opportunity. The data record includes an indication of at least one of an assigned feature writer, a deadline, a feature focus, and an assigned category. The data record is transmitted to at least one subscriber to the particular category.

### DESCRIPTION OF DRAWINGS

The invention is described with reference to the accompanying drawings.

FIG. 1 illustrates an exemplary embodiment of the architecture of a system according to an embodiment of the invention.

FIG. 2 illustrates processing logic associated with tracking and targeting feature editorial opportunities in accordance with an exemplary embodiment of the invention.

FIG. 3 illustrates processing logic associated with a determination of feature editorial opportunities to display to public relations personnel in accordance with an exemplary embodiment of the invention.

FIG. 4 illustrates a user interface configured to enable PR professionals to select criteria for searching the editorial opportunity database in accordance with an exemplary embodiment of the invention.

FIGS. 5-6 illustrate exemplary displays presented to a PR professional resulting from searches of the editorial opportunity database.

FIGS. 7-10 illustrate exemplary editorial opportunity database records that can be emailed to subscribers.

### DETAILED DESCRIPTION OF THE INVENTION

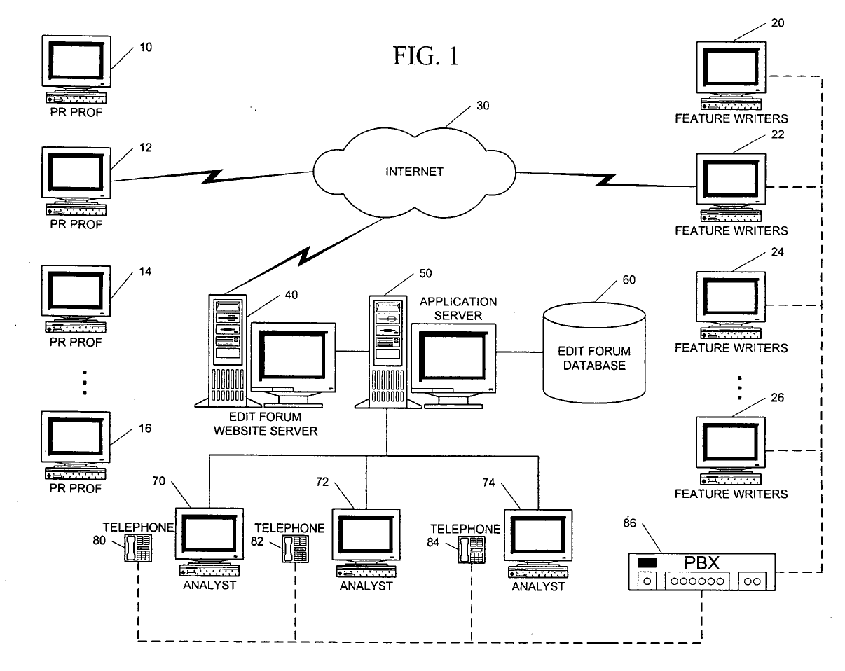

FIG. 1 illustrates an exemplary embodiment of the architecture of a system according to an embodiment of the invention. The system includes an editorial opportunity website server 40, along with editorial opportunity application server 50 and editorial opportunity database 60. The editorial opportunity database 60 stores current and historical information for a plurality of editorial opportunities in a plurality of assigned categories. For simplicity, the figure shows public relations (PR) professionals 10, 12, 14, 16; feature writers 20, 22, 24, 26; and editorial opportunity analysts 70, 72, 74. Each feature writer 20, 22, 24, 26 prepares feature articles for at least one of multiple business and technology trade publications. Editorial opportunity analysts 70, 72, 74 contact feature writers/editorial assistants 20, 22, 24, 26 to obtain information associated with the focus and deadline for each editorial opportunity. The editorial opportunity analyst contacts the feature writer/editorial assistant by telephone 80, 82, 84, by electronic mail, network or wireless communications. The individual PR professionals 10, 12, 14 16, and feature writers 20, 22, 24, 26 can then access the editorial opportunity website server from individual personal computers, laptops, personal digital assistants, workstations, etc. via a dial-up connection or dedicated connection over the Internet 30. In the discussions that follow, the editorial opportunity analysts are referred to collectively as the service provider.

Suitable implementations of access devices/computers include devices such as laptop computers, wireless telephones, portable workstations, personal data assistants (“PDA's”), pagers, and various other portable electronic communication devices capable of carrying out similar activities. Where such devices are used, PR professionals may utilize conventional methods to provide input.

While disclosed herein as the Internet, the network 30 may be any form of interconnecting network including an intranet, such as a local or wide area network, or an extranet, such as the World Wide Web or the Internet. Network 30 can be physically implemented on a wireless or wired network, on leased or dedicated lines, including a virtual private network (VPN). Network 30 can be any type of communications network, such that computers and wireless devices, whether a laptop, hand-held electronic device or a cellular telephone, can both access databases and systems to retrieve and view information. The invention may be used in conjunction with a wireless operating system such as the Wireless Application Protocol (WAP).

In one embodiment, the system is a WINDOWS based system. In another embodiment, the system is a PALM based system. In yet a further embodiment, the system is a UNIX based system. The system may also be Internet-based and generate web-browser and web page data, such as HTML, JavaScript, Java applets, etc.

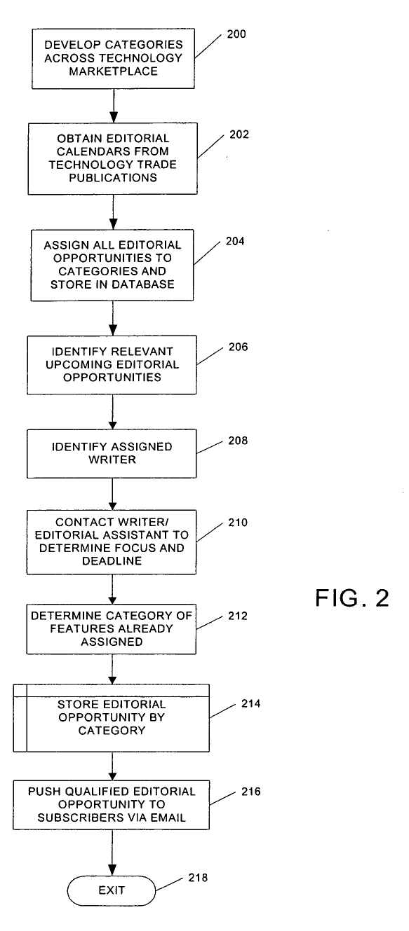

FIG. 2 illustrates the processing logic associated with tracking and targeting feature editorial opportunities. The processing starts in logic block 200 with the development of editorial opportunity categories across the technology marketplace. This is not a limiting step, as it is contemplated that additional categories will be defined and added as new technologies start to emerge. The processing continues in logic block 202 with the editorial opportunity website service provider obtaining editorial calendars from the ever-growing list of business and technology trade publications. Next, as indicated in logic block 204, each of the editorial opportunities from the trade publications is assigned to one of the categories and stored in the editorial opportunity database. In logic block 206, the service provider identifies relevant upcoming features to be published in the plurality of trade publications. The writer responsible for each feature is identified as indicated in logic block 208. The writer, or editorial assistant, is then contacted either electronically via email, or by phone to determine the focus of the article and the writer's deadlines. This processing step is indicated in logic block 210. The category most closely associated with the focus can be determined, for example, as indicated in logic block 212. The editorial opportunity is then stored in the editorial opportunity database as indicated in logic block 214. Editorial opportunities from the editorial opportunity database are then pushed to subscribers (i.e., PR professionals) via email, as indicated in logic block 216. The editorial opportunity database can also be searched by PR professionals based on deadline, opportunity date range or publication as discussed below.

To search the editorial opportunity database, the PR professional at an agency or working in a corporate PR function points his browser to the feature editorial opportunities website and selects an “Edit Forum” choice. The PR professional is then presented with a multiplicity of defined categories, and subscribes to one or more categories. The editorial opportunities website automatically provides to the subscriber timely detailed information, including writer, focus, deadline, for all editorial opportunities within subscriber-selected categories. Examples of categories for technology trade publication resources are shown in Table 1.

TABLE 1

Technology Categories
Application Development, Project Management
Database Management, Data Mining, Data Warehousing,
Supply Chain, Decision Support
Document Management, Imaging, Workflow, Content
Management, Knowledge Management
eCommerce, eProcurement, Supply Chain
Enterprise Application Solutions
Hardware, Operating Systems, Storage
Management-System, Network, Application, Asset
Middleware, Transaction Processing, Software Architecture
Mobile Computing
Network Applications
Network Infrastructure
Security, Disaster Recovery
Services-Outsourcing, Systems Integration

In addition to the editorial feature category publish-and-subscribe service, the editorial opportunity website offers the journalism community a technology press clearinghouse service. Under this service, journalists can register a requirement for a source on a given technology subject.

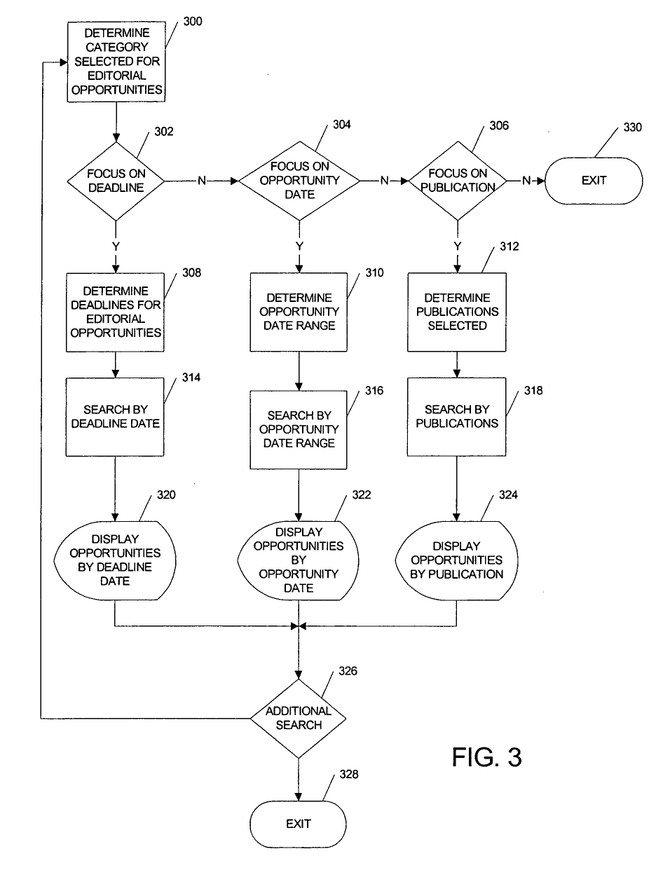

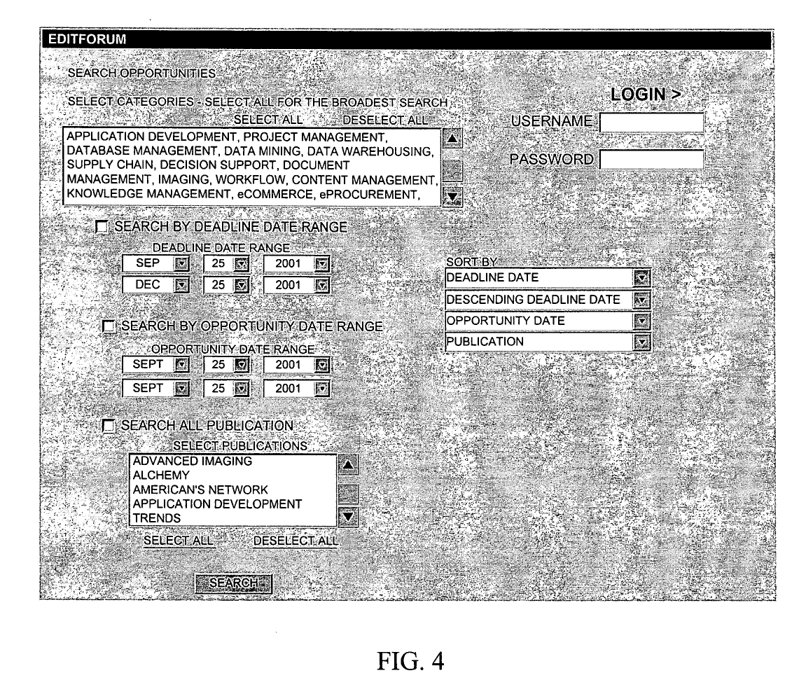

FIG. 3 illustrates the processing logic associated with a determination of feature editorial opportunities to display to public relations personnel. FIG. 4 illustrates an associated user interface input screen for the PR professional to enter a search request to the editorial opportunity database. As illustrated in FIG. 4, the PR professional can initiate searches by deadline date range, opportunity date range, and publications of interest. The PR professional can also initiate searches by descending deadline date range or by descending opportunity date range.

Processing starts in logic block 300 with a determination of the category selected to be searched for editorial opportunities. A test is then made in decision block 302 to determine if a focus on deadline date has been selected. If it has, the deadline date range for editorial opportunities entered by the PR professional is then determined from the entry via the user interface as indicated in logic block 308. The editorial opportunity database is then searched by deadline date range as indicated in logic block 314. The editorial opportunities are displayed by deadline date range as indicated in display block 320.

If a determination is made in decision block 302 that a focus on deadline was not selected by the PR professional, a test is then made in decision block 304 to determine if a focus on opportunity has been selected. If it has, the opportunity date range is then determined from the user interface entry as indicated in logic block 310. The editorial opportunity database is then searched by opportunity date range as indicated in logic block 316. The editorial opportunities are displayed by opportunity date range as indicated in display block 322.

If a determination is made in decision block 304 that a focus on opportunity was not selected by the PR professional, a test is then made in decision block 306 to determine if a focus on publication has been selected. If it has, the publications selected are then determined from the user interface entry as indicated in logic block 312. The editorial opportunity database is then searched by publications as indicated in logic block 318. The editorial opportunities are displayed by publication as indicated in display block 324. If the PR professional fails to select any focus in decision blocks 302, 304 and 306, processing exits as indicated in termination block 330.

After editorial opportunities are displayed to the PR professional in display blocks 320, 322 or 324, a determination is then made as to whether or not the PR professional wants to do an additional search of the database. If yes, then processing returns to logic block 300. Otherwise, processing exits as indicated in termination block 328. As also indicated in FIG. 3, if no focus (deadline, opportunity, or publication) has been selected as determined by decision blocks 302, 304, 306, then processing loops back to logic block 300 to await further input from the PR professional.

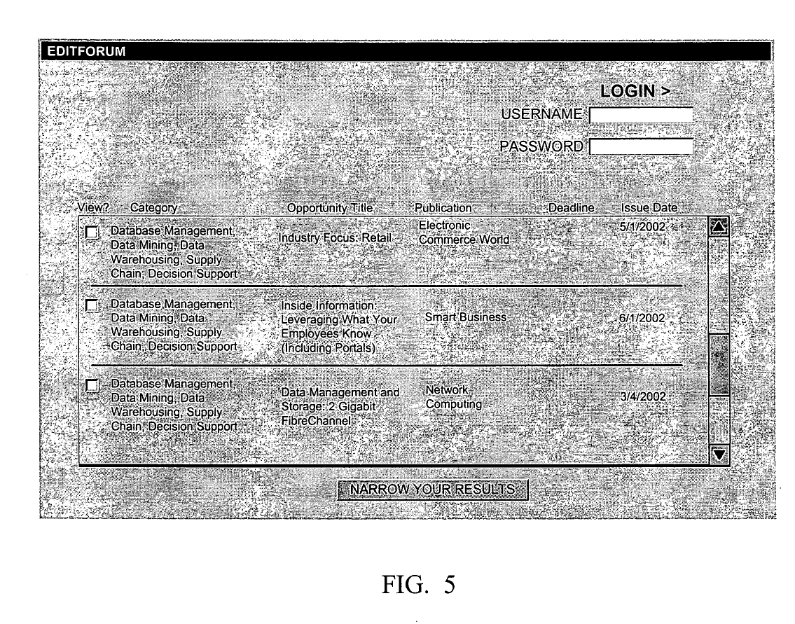

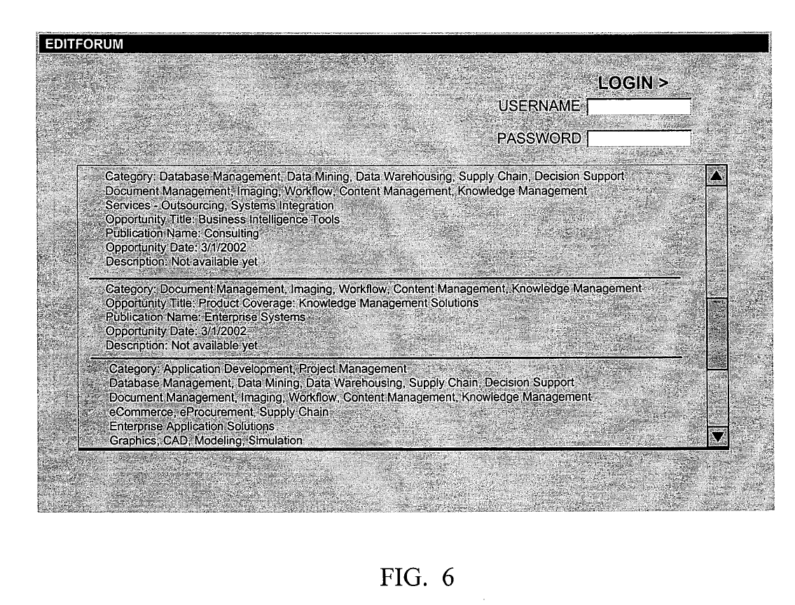

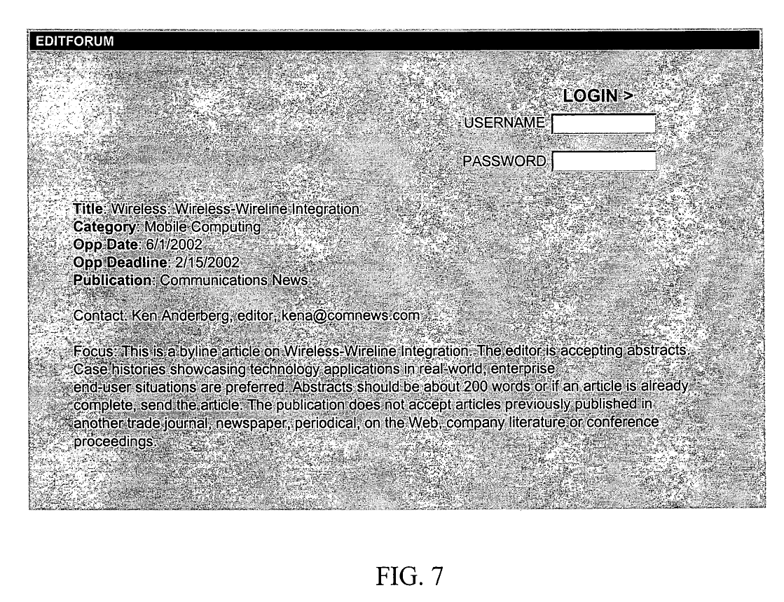

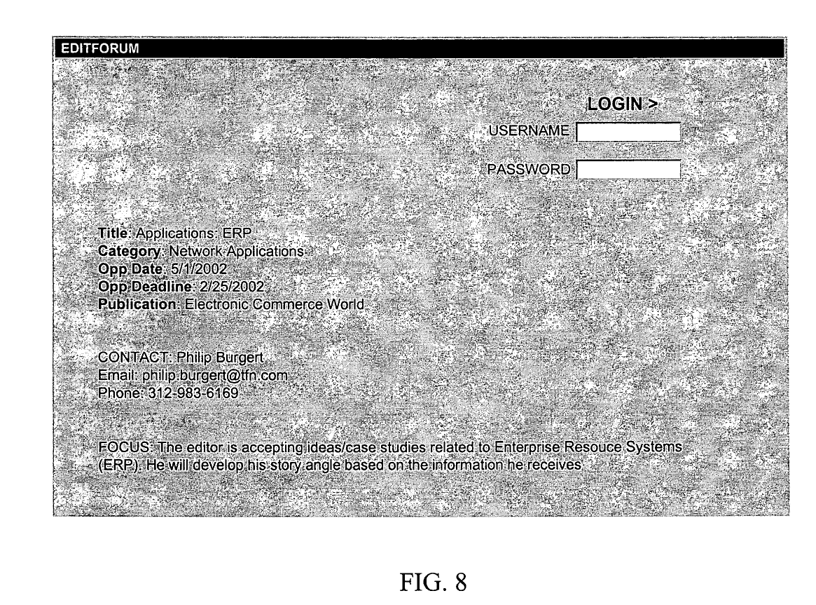

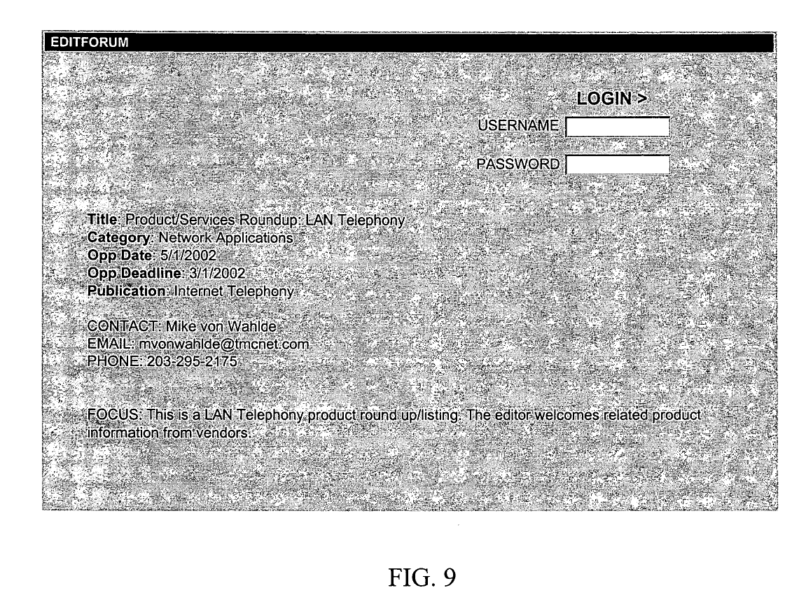

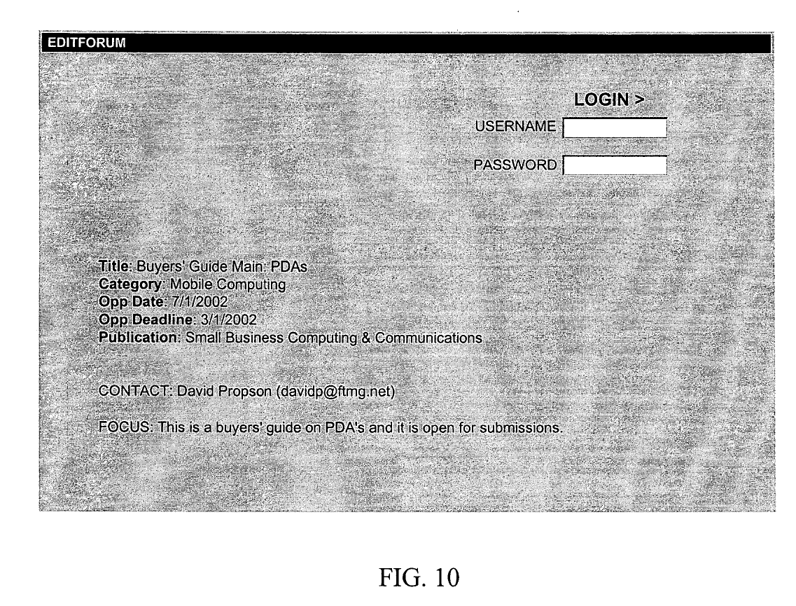

FIGS. 5-6 illustrate exemplary displays presented to a PR professional resulting from searches of the editorial opportunity database. FIGS. 7-10 illustrate exemplary editorial opportunity database records that can be emailed to subscribers. Each figure depicts feature title, category, opportunity date, opportunity deadline, publication, contact and feature focus.

Also available on the editorial opportunity website is a page that lists all of the trade publications that are tracked by the system of the invention. Each publication can be “clicked on” which generates a hyperlink connection to the selected publication website, where current online issues of the publication can be viewed directly.

The feature editorial opportunities tracking system of the invention can be realized in software or a combination of hardware and software. Any kind of computer system or other apparatus adapted for carrying out the methods described herein is suitable. A typical combination of hardware and software in this context could be a web-based server computer with a computer program that, when loaded and executed, controls the web-based server computer such that it carries out the methods described herein. The feature editorial opportunities tracking system can be embedded in a computer program product, which includes all the features enabling the implementation of the methods described herein, and which, when loaded in a computer system, is able to carry out these methods.

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalence.

The previous description of the embodiments is provided to enable any person skilled in the art to make or use the invention. While the invention has been particularly shown and described with reference to embodiments thereof, it will be understood by those skilled in art that various changes in form and details may be made therein without departing from the spirit and scope of the invention.

What is claimed is:

1. A method, comprising:
receiving data associated with at least one editorial opportunity, the data based on features contained in at least one editorial calendar;
associating the received at least one editorial opportunity with at least one of a client and a category from a plurality of categories;
receiving information associated with a data record for the at least one editorial opportunity, the data record including an indication of at least one of an assigned feature writer, a deadline, a feature focus, and an assigned category; and
transmitting the data record for the at least one editorial opportunity in the at least one category to at least one subscriber to the category.

2. The method of claim 1, wherein the receiving data includes receiving data via manual data entry.

3. The method of claim 1, wherein the receiving data includes receiving data electronically.

4. The method of claim 1, wherein the category includes at least one of Application Development, Project Management, Database Management, Data Mining, Data Warehousing, Supply Chain, Decision Support, Document Management, Imaging, Workflow, Content Management, Knowledge Management, eCommerce, eProcurement, Supply Chain, Enterprise Application Solutions, Hardware, Operating Systems, Storage Management-System, Network, Application, Asset, Middleware, Transaction Processing, Software Architecture, Mobile Computing, Network Applications, Network Infrastructure, Security, Disaster Recovery, Services-Outsourcing and Systems Integration.

5. The method of claim 1, wherein the receiving information includes:
identifying the feature writer assigned to prepare the at least one editorial opportunity; and
contacting the feature writer assigned to prepare the at least one editorial opportunity to determine the feature focus and the deadline.

6. The method of claim 1, wherein transmitting the data record includes sending the data record via electronic mail.

7. The method of claim 1, wherein transmitting the data record includes posting the data record over a network.

8. A method, comprising:
receiving a select command to indicate a category from a plurality of categories to search for at least one editorial opportunity from a plurality of editorial opportunities;
receiving a focus command to determine a search parameter for the plurality of editorial opportunities in the selected category;
searching an editorial opportunity database based on the focus command to retrieve a data record matching the search criteria, the data record including an indication of at least one of an assigned feature writer, a deadline, a feature focus, and an assigned category; and
displaying the retrieved data record.

9. The method of claim 8, wherein the search parameter includes at least one of a deadline date range, a descending deadline date range, an opportunity date range, a descending opportunity date range and a publication.

10. The method of claim 8, wherein the plurality of categories is predefined, and each of the editorial opportunities is assigned to a specific category based on a feature focus for the editorial opportunity.

11. The method of claim 8, further comprising:
identifying the feature writer assigned to prepare the at least one editorial opportunity; and
contacting the feature writer assigned to prepare the at least one editorial opportunity to determine the feature focus and the deadline.

12. Processor executable code stored on a processor-readable medium, the code comprising:
code for receiving data associated with at least one editorial opportunity, the data based on features contained in at least one editorial calendar;
code for associating the received at least one editorial opportunity with at least one of a client and a category from a plurality of categories;
code for receiving information associated with a data record for the at least one editorial opportunity, the data record including an indication of at least one of an assigned feature writer, a deadline, a feature focus, and an assigned category; and
code for transmitting the data record for the at least one editorial opportunity in the at least one category to at least one subscriber to the category.

13. A system, comprising:
a storage device including data associated with at least one editorial opportunity, the data based on features contained in at least one editorial calendar; and
a device configured to retrieve information associated with a data record for the at least one editorial opportunity, the data record including an indication of at least one of an assigned feature writer, a deadline, a feature focus, and an assigned category, the device further configured to transmit the data record for the at least one editorial opportunity, the data record viewable by a subscriber.

14. The system of claim 13, wherein the storage device is in communication with a subscriber device, the subscriber terminal configured to receive the data record.

15. The system of claim 14, wherein the storage device is in wireless communication with the subscriber device.

16. The system of claim 14, wherein the device is a network terminal coupled to the storage device and the subscriber device is a wireless device.
